(19) United States
(12) Patent Application Publication
(10) Pub. No.: US 2012/0248725 A1
(43) Pub. Date: Oct. 4, 2012

(54) SUSPENSION SYSTEM WITH ARTICULATION COMPLIANT SPRING BEAM BUSHING

(75) Inventor: Thomas N. CHALIN, Fairview, TX (US)

(73) Assignee: Watson & Chalin Manufacturing, Inc., McKinney, TX (US)

(21) Appl. No.: 13/073,076

(22) Filed: Mar. 28, 2011

(51) Int. Cl. B60G 9/02

(52) U.S. Cl. 280/124.11

(57) ABSTRACT

A suspension system can include a spring beam with a bushing receiving opening having outer ends with larger dimensions as compared to an intermediate section of the opening. Another suspension system can include a spring beam having a bushing receiving opening, a resilient bushing received in the opening, and a rigid sleeve received in the bushing, a radial distance between the sleeve and the opening being reduced between opposite ends of the opening. Another suspension system can include an axle, a spring beam attached to the axle, the spring beam including a bushing receiving opening, and a resilient bushing received in the opening, the bushing having outer ends with larger outer dimensions as compared to an intermediate section of the bushing between the bushing outer ends.

### BACKGROUND

This disclosure relates generally to equipment utilized and operations performed in conjunction with vehicle suspension systems and, in an example described below, more particularly provides a suspension system with an articulation compliant spring beam bushing.

In a typical spring beam suspension system, axle articulation causes transmission of torque through spring beams. The torque is transmitted through the spring beams between axle clamps securing the spring beams to an axle, and pivot connections between the spring beams and hangers attached to a vehicle frame.

Past efforts to deal with this articulation torque in the spring beams have focused on improving the torque-resisting capabilities of the pivot connections, spring beams and axle clamps. The present inventor has, however, taken a different approach.

### SUMMARY

In the disclosure below, a unique way of constructing a spring beam suspension system is provided which brings improvements to the art. One example is described below in which a spring beam pivot bushing is configured so that it is more compliant to rotation of a spring beam. An example suspension system described below has a pivot connection which accommodates axle articulation and reduces torque transmitted through spring beams.

In one aspect, a spring beam suspension system described below can include an axle, and a spring beam attached to the axle. The spring beam includes a bushing receiving opening, with the opening having outer ends with larger inner dimensions as compared to an intermediate section of the opening between the outer ends.

In another aspect, a spring beam suspension system described below can include a spring beam with a bushing receiving opening, a resilient bushing received in the opening, and a rigid sleeve received in the bushing. A radial distance between the sleeve and the bushing receiving opening is reduced between opposite ends of the opening.

In yet another aspect, a spring beam suspension system described below can include an axle, a spring beam attached to the axle, the spring beam including a bushing receiving opening, and a resilient bushing received in the opening. The bushing has outer ends with larger outer dimensions as compared to an intermediate section of the bushing between the bushing outer ends.

These and other features, advantages and benefits will become apparent to one of ordinary skill in the art upon careful consideration of the detailed description of representative examples below and the accompanying drawings, in which similar elements are indicated in the various figures using the same reference numbers.

### BRIEF DESCRIPTION OF THE DRAWINGS

FIG. 1 is a representative partially cross-sectional view of a vehicle which can embody principles of the present disclosure.

FIGS. 2 & 3 are somewhat enlarged scale top and side views of a spring beam suspension system which may be used in the vehicle of FIG. 1.

FIGS. 4 & 5 are further enlarged scale partially cross-sectional views of a pivot connection which may be used in the suspension system of FIGS. 2 & 3.

### DETAILED DESCRIPTION

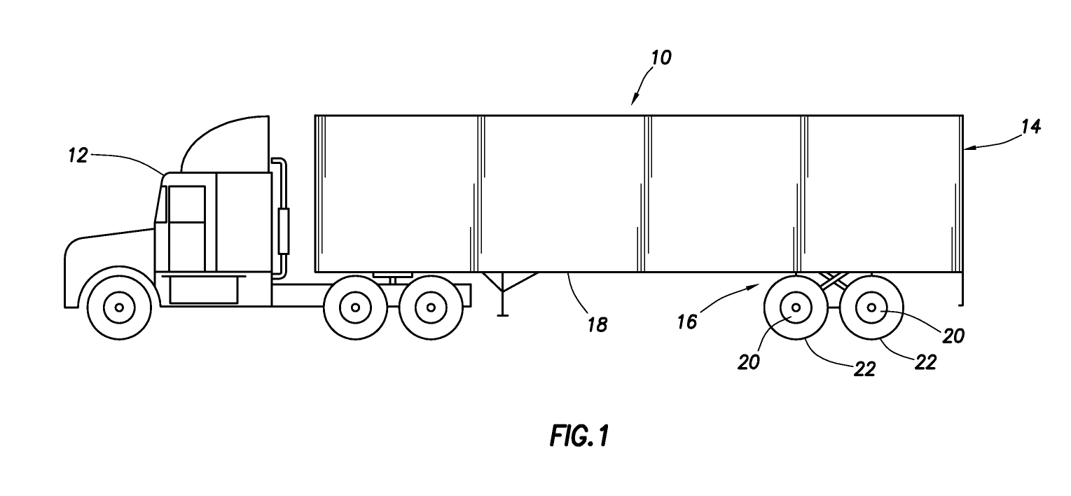

Representatively illustrated in FIG. 1 is a vehicle 10 which can embody principles of this disclosure. The vehicle 10 is depicted as including a tractor 12 and a trailer 14. However, it is contemplated that the principles of this disclosure can be incorporated into a trailer of any type (as well as other types of vehicles), and so the term “vehicle” is used herein to refer to trailers of various types, as well as to refer to self-propelled vehicles.

The trailer 14 of FIG. 1 includes multiple suspension systems 16 which suspend a frame 18 of the trailer above a road surface. Wheels 20 and tires 22 are rotatably mounted at each end of each suspension system 16.

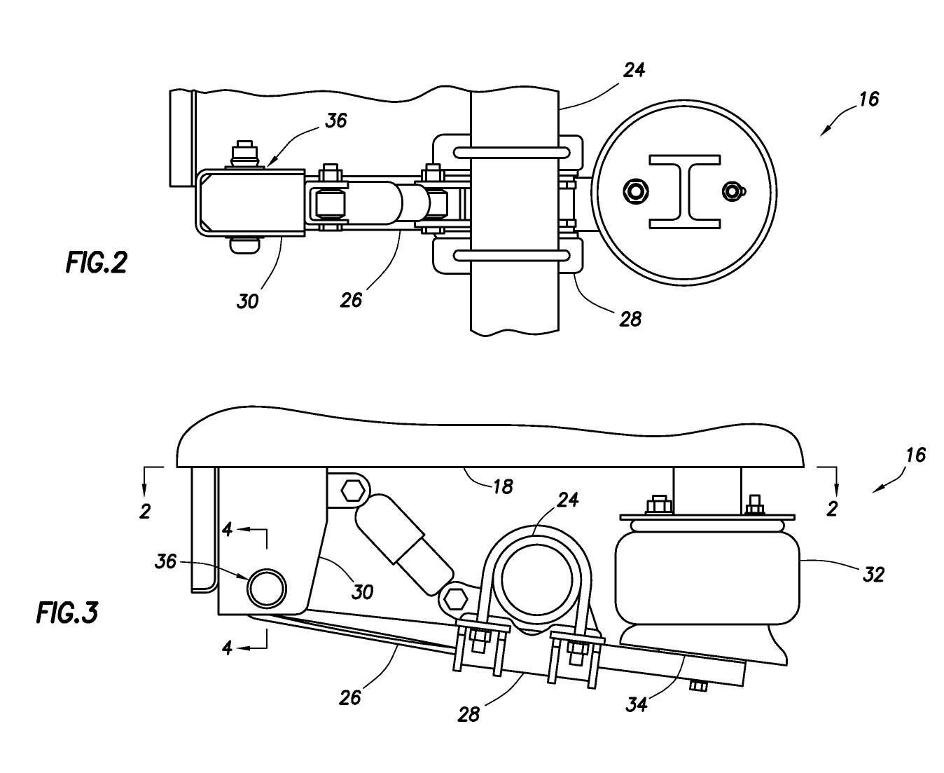

Referring additionally now to FIGS. 2 & 3, top and side views of one side of one of the suspension systems 16 is representatively illustrated. The suspension system 16 can be used with vehicles other than the vehicle 10 depicted in FIG. 1, in keeping with the principles of this disclosure.

The suspension system 16 includes an axle 24. The wheels 20 and tires 22 are mounted at each end of the axle 24 using, for example, spindles, hubs, bearings, etc.

The axle 24 is clamped to a spring beam 26 using, for example, an axle clamp 28. A forward end of the spring beam 26 is pivotably attached to a hanger 30, which is secured under the frame 18 (e.g., by welding and/or fasteners, etc.).

A rearward end of the spring beam 26 supports an air spring 32 on an air spring mounting plate 34. The air spring 32 exerts an upwardly directed biasing force to the frame 18.

An advantage of the spring beam suspension system 16 is that the spring beam 26 is designed to bend somewhat between the hanger 30 and the mounting plate 34 when the axle 24 is deflected vertically. However, a problem with conventional spring beam suspension systems is that axle articulation (i.e., rotation of the axle about a longitudinal axis of the vehicle, caused by opposite ends of a suspension system being at different heights relative to the frame) causes longitudinal twisting of the spring beams, which is resisted at the pivot connections to the hangers.

The result is that relatively large torque is transmitted through the spring beams. Therefore, the spring beams need to be designed to withstand the torque due to axle articulation, and the axle clamps need to be designed to transmit the torque between the spring beams and the axle.

It will be appreciated that, if the torque transmitted through the spring beam 26 can be reduced, stresses in the spring beam, axle clamp 28 and other components of the suspension system 16 can also be reduced. This can produce benefits, such as, reduced weight, reduced stress fatigue failure of suspension components, etc.

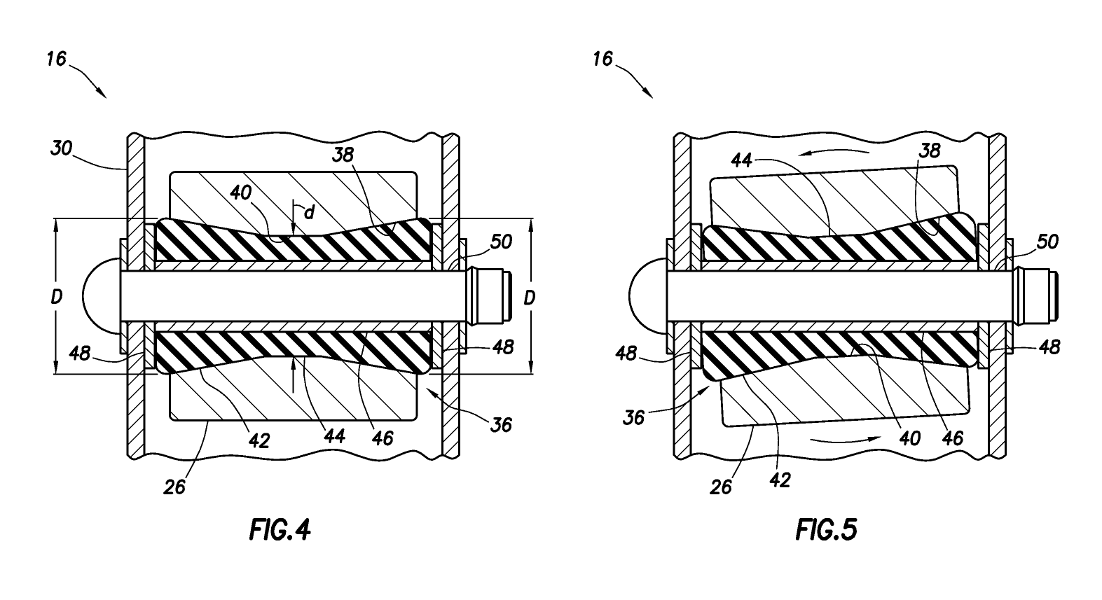

The suspension system 16 achieves these benefits, and others, with a unique pivot connection 36 between the spring beam 26 and the hanger 30. A cross-sectional view of the pivot connection 36 is representatively illustrated in FIG. 4.

As depicted in FIG. 4, the spring beam 26 has an “eye” formed at its forward end, with the forward end of the spring beam being wrapped about and forming an opening 38. The opening 38 has at its outer ends a larger dimension D, as compared to a dimension d at an intermediate section 40 of the opening between the outer ends.

A bushing 42 is received in the opening 38. The bushing 42 is preferably made of a resilient material, such as an elastomer. The bushing 42 is also preferably made of a single piece of material, although multiple layers could be used, if desired, but preferably the bushing material is at least laterally continuous.

Shaped complementary to the opening 38, the bushing 42 has larger dimensions D at its opposite ends, and the smaller dimension d at its intermediate section 44. A rigid inner sleeve 46 may be bonded or otherwise adhered to the bushing 42 when it is installed in the opening 38, or the sleeve could be inserted into the bushing after it is installed in the opening.

Washers or spacers 48 may be used between the sleeve 46 and the hanger 30. Polyurethane washers could also be used between the bushing 42 and the hanger 30. Any combination of washers or spacers, any sizes of washers or spacers, or no washers or spacers, could be used.

A pin 50 (preferably in the form of a fastener known to those skilled in the art as a “huck”) extends through the sleeve 46 and secures the bushing 42, sleeve and spring beam 26 in the hanger 30. The bushing 42 and spring beam 26 rotate about the pin 50 and sleeve 46 when the spring beam pivots relative to the hanger 30.

The bushing 42 could be made of various materials, such as polyurethane, rubber, etc. If made of polyurethane, the bushing 42 may rotate about the sleeve 46. If made of rubber, the bushing 42 may stretch and deform (instead of rotating) when the spring beam 26 rotates about the sleeve 46.

Although the bushing 42 is depicted in FIGS. 4 & 5 as being integrally formed of a single piece of material, in other examples, the bushing could be made in two or more pieces.

In one unique feature of the pivot connection 36, the complementary shapes of the opening 38 and the bushing 42 function to resist lateral movement of one component relative to the other. Thus, the bushing 42 is less likely to migrate toward one side of the opening 38, and the spring beam 26 is less likely to migrate toward one side of the hanger 30.

In another unique feature, the outer sides of the bushing 42 are more compliant (less stiff) as compared to the intermediate section 44 of the bushing. This is due to there being more resilient material with greater radial thickness at the outer sides of the bushing 42, as compared to at the intermediate section 44.

As a result, the bushing 42 is more compliant to twisting of the spring beam 26, but still has adequate stiffness to resist deflections of the spring beam radially relative to the pin 50 (e.g., due to braking loads, etc.). Twisting of the spring beam 26 is depicted in FIG. 5. Note that the bushing 42 is able to deform relatively easily at its outer ends, thereby accommodating the rotation of the spring beam 26, instead of attempting to prevent it at the pivot connection 36.

It will now be appreciated that the concepts described above provide advancements to the art of suspension system design. Since resistance to the twisting of the spring beam 26 at the pivot connection 36 is reduced, the torque transmitted through the spring beam, axle clamp 28 and other components of the suspension system 16 is also reduced, and the weight of, and stress in, those components can also be reduced.

In particular, the above disclosure provides to the art a spring beam suspension system 16 which can include an axle 24 and a spring beam 26 attached to the axle 24. The spring beam 26 can bend in response to vertical displacement of the axle 24.

The spring beam 26 includes a bushing receiving opening 38, the opening 38 having outer ends with larger inner dimensions D as compared to an intermediate section 40 of the opening 38 between the outer ends. The spring beam 26 may wrap at least partially about the opening 38.

A resilient bushing 42 disposed in the opening 38 can have outer ends with larger outer dimensions D as compared to an intermediate section 44 of the bushing 42 between the bushing outer ends. The bushing 42 outer ends and the bushing intermediate section 44 may be integrally formed of a single piece of material. The bushing 42 outer ends can have reduced stiffness as compared to the bushing intermediate section 44.

The opening intermediate section 40 can laterally retain the bushing 42 in the opening 38.

The suspension system 16 can also include an axle clamp 28 which clamps the axle 24 to the spring beam 26.

Also described above is the spring beam suspension system 16 which comprises a spring beam 26 including a bushing receiving opening 38, a resilient bushing 42 received in the opening 38, and a rigid sleeve 46 received in the bushing 42. A radial distance between the sleeve 46 and the bushing receiving opening 38 is reduced between opposite ends of the opening 38.

A spring beam suspension system 16 described above can include an axle 24 and a spring beam 26 attached to the axle 24, the spring beam 26 including a bushing receiving opening 38, and a resilient bushing 42 received in the opening 38, the bushing 42 having outer ends with larger outer dimensions D as compared to an intermediate section 44 of the bushing 42 between the bushing outer ends.

However, it should be clearly understood that the embodiments illustrated in the drawings are depicted and described merely as examples of useful applications of the principles of the disclosure, which are not limited to any specific details of these embodiments.

Of course, a person skilled in the art would, upon a careful consideration of the above description of representative embodiments, readily appreciate that many modifications, additions, substitutions, deletions, and other changes may be made to these specific embodiments, and such changes are within the scope of the principles of the present disclosure. Accordingly, the foregoing detailed description is to be clearly understood as being given by way of illustration and example only, the spirit and scope of the present invention being limited solely by the appended claims and their equivalents.

What is claimed is:

1. A spring beam suspension system, comprising:
an axle; and
a spring beam attached to the axle, the spring beam including a bushing receiving opening, the opening having outer ends with larger inner dimensions as compared to an intermediate section of the opening between the outer ends.

2. The suspension system of claim 1, further comprising a resilient bushing disposed in the opening, the bushing having outer ends with larger outer dimensions as compared to an intermediate section of the bushing between the bushing outer ends.

3. The suspension system of claim 2, wherein the bushing outer ends and the bushing intermediate section are integrally formed of a single piece of material.

4. The suspension system of claim 2, wherein the bushing outer ends have reduced stiffness as compared to the bushing intermediate section.

5. The suspension system of claim 2, wherein the opening intermediate section laterally retains the bushing in the opening.

6. The suspension system of claim 1, wherein the spring beam wraps at least partially about the opening.

7. The suspension system of claim 1, further comprising an axle clamp which clamps the axle to the spring beam.

8. A spring beam suspension system, comprising:
a spring beam including a bushing receiving opening;
a resilient bushing received in the opening; and
a rigid sleeve received in the bushing, a radial distance between the sleeve and the bushing receiving opening being reduced between opposite ends of the opening.

9. The suspension system of claim 8, wherein the opening opposite ends have larger inner dimensions as compared to an intermediate section of the opening between the opposite ends.

10. The suspension system of claim 9, wherein the opening intermediate section laterally retains the bushing in the opening.

11. The suspension system of claim 8, wherein the bushing has outer ends with larger outer dimensions as compared to an intermediate section of the bushing between the bushing outer ends.

12. The suspension system of claim 11, wherein the bushing outer ends and the bushing intermediate section are integrally formed of a single piece of material.

13. The suspension system of claim 11, wherein the bushing outer ends have reduced stiffness as compared to the bushing intermediate section.

14. A spring beam suspension system, comprising:
an axle;
a spring beam attached to the axle, the spring beam including a bushing receiving opening; and
a resilient bushing received in the opening, the bushing having outer ends with larger outer dimensions as compared to an intermediate section of the bushing between the bushing outer ends.

15. The suspension system of claim 14, wherein the bushing outer ends and the bushing intermediate section are integrally formed of a single piece of material.

16. The suspension system of claim 14, wherein the bushing outer ends have reduced stiffness as compared to the bushing intermediate section.

17. The suspension system of claim 14, wherein the opening has outer ends with larger inner dimensions as compared to an intermediate section of the opening between the outer ends.

18. The suspension system of claim 17, wherein the opening intermediate section laterally retains the bushing in the opening.

19. The suspension system of claim 14, wherein the spring beam wraps at least partially about the opening.

20. The suspension system of claim 14, further comprising an axle clamp which clamps the axle to the spring beam.
